(19) United States
(12) Patent Application Publication
(10) Pub. No.: US 2008/0049965 A1
(43) Pub. Date: Feb. 28, 2008

(54) Speaker device

(75) Inventor: Takeshi Iwata, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/892,669

(22) Filed: Aug. 24, 2007

(30) Foreign Application Priority Data
Aug. 24, 2006 (JP) 2006-227616

(51) Int. Cl. H04R 1/02

(52) U.S. Cl. 381/394

(57) ABSTRACT

A speaker device includes a terminal metal which is electrically connectible to a tinsel cord and a wiring, and a supporting body which includes a terminal metal mounting part on which the terminal metal is mounted. The terminal metal is mounted on the terminal metal mounting part. Thereby, the tinsel cord and the wiring can be electrically connected to each other via the terminal metal, without providing a terminal board. Thus, the number of parts can be reduced by the number of omitted terminal board, and the cost of the speaker device can be reduced.

### BACKGROUND OF THE INVENTION

1. Field of the Invention

The present invention relates to a configuration of mounting of a terminal metal on a speaker device.

2. Description of Related Art

Conventionally, it is general that, in a speaker device, a tinsel cord electrically connected to a lead wire of a voice coil and a wiring drawn from a connector terminal are electrically connected to each other via a terminal metal of a terminal board. The terminal metal is mounted by a fixing method such as a method of using a metal eyelet on the terminal board mounted on a frame.

For example, as the speaker device having the terminal metal mounting configuration of this kind, there is known a waterproof speaker device in which a terminal having a cord connected to a connector is mounted on a frame made of a resin material (see Japanese Patent Application Laid-open under No. 9-84166, for example).

A speaker device in which a terminal connected to a tinsel cord is fixed to a connector part integrated with a frame is disclosed in Japanese Patent Application Laid-open under No. 8-79866. Additionally, a speaker device in which a conductive terminal and a terminal are integrated with each other and the terminal is fixed to a resin frame is disclosed in Japanese Patent Application Laid-open under No. 9-130890. In the speaker device according to the latter reference, one end of the conductive terminal is fixed to a conductive tinsel cord by soldering, and the other end of the conductive terminal is integrated with and fixed to an integration terminal of the connector by soldering.

An on-vehicle speaker device is disclosed in Japanese Patent Application Laid-open under No. 11-341574. This on-vehicle speaker device includes a terminal part which is supported by a frame and connected to a voice coil via a lead wire, and the terminal part is connected to a connector of a cable for inputting a sound current.

However, as described above, if the speaker device includes the terminal board for connecting the tinsel cord and the wiring, the cost of the speaker device problematically becomes high by the amount of terminal board.

### SUMMARY OF THE INVENTION

The present invention has been achieved in order to solve the above problem. It is an object of this invention to provide a speaker device having a terminal metal mounting configuration mainly capable of reducing the cost.

According to one aspect of the present invention, there is provided a speaker device including: a terminal metal which is electrically connectible to a tinsel cord and a wiring; and a supporting body which includes a terminal metal mounting part on which the terminal metal is mounted, wherein the terminal metal is mounted on the terminal metal mounting part.

The above speaker device includes the terminal metal electrically connectible to the tinsel cord and the wiring, and the supporting body having the terminal metal mounting part on which the terminal metal is mounted. It is preferable that the tinsel cord is electrically connected to the voice coil and the wiring is electrically connected to an amplifier. The terminal metal is mounted on the terminal metal mounting part. Thereby, the tinsel cord and the wiring can be electrically connected to each other via the terminal metal without providing the terminal board. Thus, the number of parts can be reduced by the number of omitted terminal board, and the cost of the speaker device can be reduced.

In a manner of the above speaker device, the terminal metal mounting part may include an insertion hole for mounting the terminal metal. Thus, by inserting the terminal metal into the insertion hole of the terminal metal mounting part, the terminal metal can be mounted on the terminal metal mounting part. Therefore, the work of mounting of the terminal metal on the terminal metal mounting part becomes easy.

In another manner of the above speaker device, the terminal metal mounting part may include a claw part formed into a claw shape for fixing the terminal metal, provided at a position opposite to the insertion hole, and the terminal metal may include an engagement hole engaging with the claw part. Apart of the terminal metal may be inserted into the insertion hole, and the claw part may engage with the engagement hole. Thereby, the terminal metal can be securely fixed to the terminal metal mounting part, and it can be prevented that the terminal metal is separated from the terminal metal mounting part.

In another manner of the above speaker device, a cut-out part formed by cutting out a part of the terminal metal mounting part may be provided on both sides of the claw part, and the claw part may have a length having elasticity. In a preferred example, the claw part may have a length capable of bending in a direction of enlarging one end side of the insertion hole. Thereby, the terminal metal can be easily inserted into the insertion hole, and the claw part can easily engage with the engagement hole of the terminal claw.

In another manner of the above speaker device, the terminal metal mounting part, having a shape surrounding the claw part and a recessed shape, may include an adhesive accumulation part in which an adhesive of a constant amount is filled. The part of the terminal metal positioned in the adhesive accumulation part may be exposed. The part of the terminal metal may be fixed to the terminal metal mounting part via the adhesive filled in the adhesive accumulation part.

Thereby, it can be prevented that the adhesive extrudes from the adhesive accumulation part, and the terminal metal can be securely fixed to the terminal metal mounting part via the adhesive. As a result, it can be prevented that the terminal metal backlashes against the terminal metal mounting part. Also, it can be further prevented that the terminal metal is separated from the terminal metal mounting part.

In a preferred example, the supporting body may include an outer peripheral part; an inner peripheral part provided on an inner side of the outer peripheral part; and an arm part for integrating the outer peripheral part and the inner peripheral part, and the terminal metal mounting part may be provided at the inner peripheral part. In a preferred example, the supporting body may be made of a resin material. Thereby, the terminal metal mounting part can be easily formed without increasing of the number of procedures.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a cross-sectional view of a speaker device having a mounting configuration of a terminal metal according to an embodiment of the present invention;

FIGS. 2A and 2B show a rear view and a front view of a supporting body according to the embodiment of the present invention;

FIGS. 3A and 3B show side views of the supporting body according to the embodiment of the present invention;

FIGS. 4A to 4C show a main part enlarged perspective view, a cross-sectional view and a front view of a terminal metal mounting part provided on the supporting body;

FIG. 5 shows a perspective view of the terminal metal mounted on the terminal metal mounting part of the embodiment;

FIGS. 6A to 6C show a rear view, a main part enlarged perspective view and a cross-sectional view of the speaker device, showing such a state that the terminal metal is mounted on the terminal metal mounting part of the embodiment; and

FIG. 7 shows a main part enlarged perspective view of a speaker device having a mounting configuration of a terminal metal according to a comparative example.

### DETAILED DESCRIPTION OF THE PREFERRED EMBODIMENTS

Now, a preferred embodiment of the present invention will be described below, with reference to the attached drawings.

### [Configuration of Speaker Device]

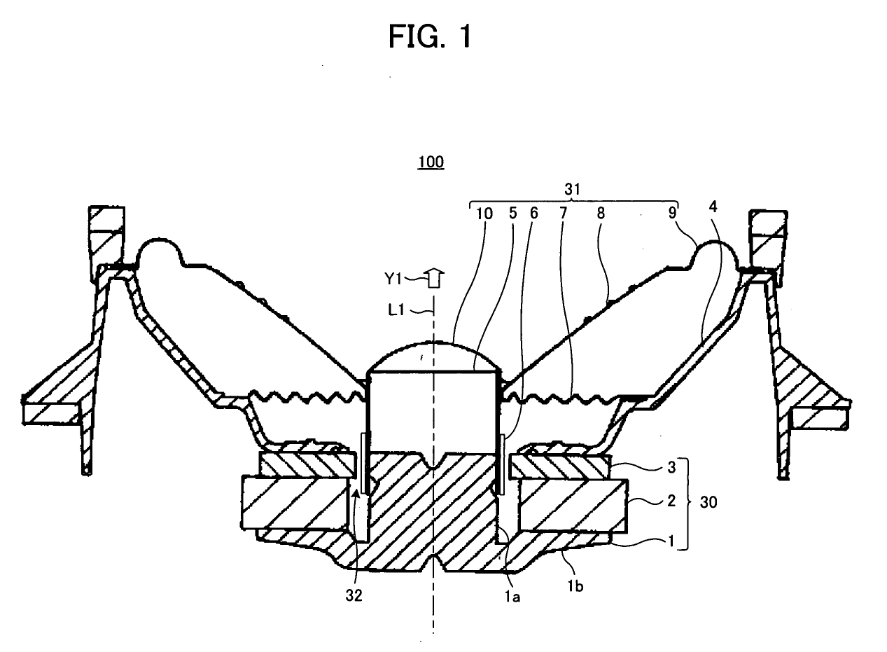

FIG. 1 shows a cross-sectional view of a speaker device 100 having a mounting configuration of a terminal metal according to an embodiment of the present invention, when cut by a plane surface passing through a central axis L1.

As shown in FIG. 1, the speaker device 100 includes a magnetic circuit 30, a supporting body 4 and a vibration system member 31. In the present invention, the configuration and a driving system of the speaker device are not limited to a manner which will be described below.

First, the configuration of the magnetic circuit 30 will be explained.

The magnetic circuit 30 includes a yoke 1, a magnet 2 and a plate 3.

The yoke 1 has a center pole 1a formed into a substantially cylindrical shape, and a flange part 1b outwardly and obliquely upwardly extending from the lower end part of the outer peripheral wall of the center pole 1a. The magnet 2, formed into an annular shape, is mounted on the flange part 1b. The plate 3, formed into an annular shape, is mounted on the magnet 2. A magnetic gap 32 in which the magnetic flux of the magnet 2 is concentrated is formed between the center pole 1a and the plate 3.

Next, a description will be given of the configuration of the supporting body 4.

The supporting body 4 serves as a frame for supporting various kinds of components of the speaker device 100. The lower end part of the supporting body 4 is mounted on the plate 3. The configuration of the supporting body 4 will be explained in details later. In this embodiment, the supporting body 4 is formed as the frame for the speaker device, which is not limited in the present invention. Namely, the supporting body 4 may be a bracket for a speaker device and a speaker box.

Next, the configuration of the vibration system member 31 will be explained.

The vibration system member 31 includes a voice coil bobbin 5, a voice coil 6, a damper 7, a diaphragm 8, an edge 9 and a cap 10.

The voice coil bobbin 5, formed into a cylindrical shape, is arranged at a position covering the upper end part of the outer peripheral wall of the center pole 1a.

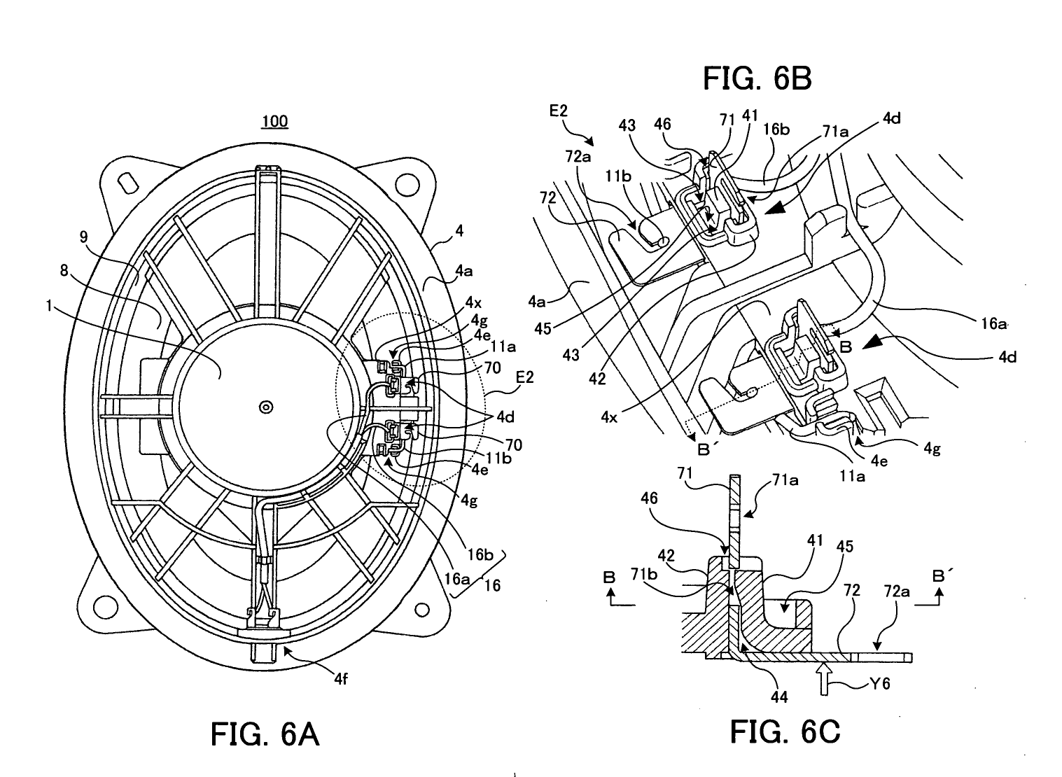

The voice coil 6 includes a pair of lead wires (not shown) including a plus lead wire and a minus lead wire, and is wound around the lower end part of the outer peripheral wall of the voice coil bobbin 5. Therefore, the voice coil 6 is arranged in the magnetic gap 32. The plus lead wire is an input wiring of an L (or R) channel signal, and the minus lead wire is an input wiring of a ground (GND) signal. The respective lead wires are electrically connected to a pair of tinsel cords 11 including a plus tinsel cord 11a and a minus tinsel cord 11b (see FIGS. 6A and 6B). The plus tinsel cord 11a and the minus tinsel cord 11b are electrically connected to a pair of wirings (cords) 16 including a plus wiring 16a and a minus wiring 16b, respectively (also see FIGS. 6A and 6B). Moreover, the pair of plus wiring 16a and minus wiring 16b are electrically connected to a connector terminal 4f, provided on the supporting body 4 and electrically connected to a pair of plus and minus output wirings of an amplifier, respectively (see FIG. 6A). Thereby, one-channel signal and power (hereinafter also simply referred to as “sound current”) are inputted to the voice coil 6 from the amplifier via the connector terminal 4f, the pair of plus and minus wirings 16, the pair of plus and minus tinsel cords 11 and the pair of plus and minus lead wires.

The damper 7 elastically supports the voice coil bobbin 5. The damper 7, formed into an annular shape, includes plural concentric corrugations. The inner peripheral edge part of the damper 7 is mounted on the vicinity of the upper end part of the outer peripheral wall of the voice coil bobbin 5, and the outer peripheral edge part of the damper 7 is mounted on the vicinity of the middle part of the supporting body 4.

The diaphragm 8, formed into a cone shape, has a function to output an acoustic wave corresponding to the input signal. The inner peripheral edge part of the diaphragm 8 is mounted on the upper end part of the outer peripheral wall of the voice coil bobbin 5.

The edge 9, having an annular shape and an Ω-shaped cross section, has a function to absorb unnecessary vibration generated on the diaphragm 8. The inner peripheral edge part of the edge 9 is mounted on the outer peripheral edge part of the diaphragm 8, and the outer peripheral edge part of the edge 9 is mounted on the upper end part of the supporting body 4.

The cap 10, formed into a dome shape, has a function to prevent dust from entering the inside of the speaker device 100. The cap 10 is mounted on a position covering the upper surface of the voice coil bobbin 5.

In the speaker device 100 having the above configuration, the sound current outputted from the amplifier is inputted to the voice coil 6 through the above-mentioned passage. Thereby, in accordance with Fleming's left-hand rule, the driving force is generated in the voice coil 6 in the magnetic gap 32, which makes the diaphragm 8 vibrate in the direction of the central axis L1 passing through the center of the speaker device 100. Thereby, the acoustic wave is outputted in the direction of an arrow Y1 via the diaphragm 8.

Next, a description will be given of a configuration of mounting of a pair of terminal metals 70 on the supporting body 4.

### (Configuration of Supporting Body)

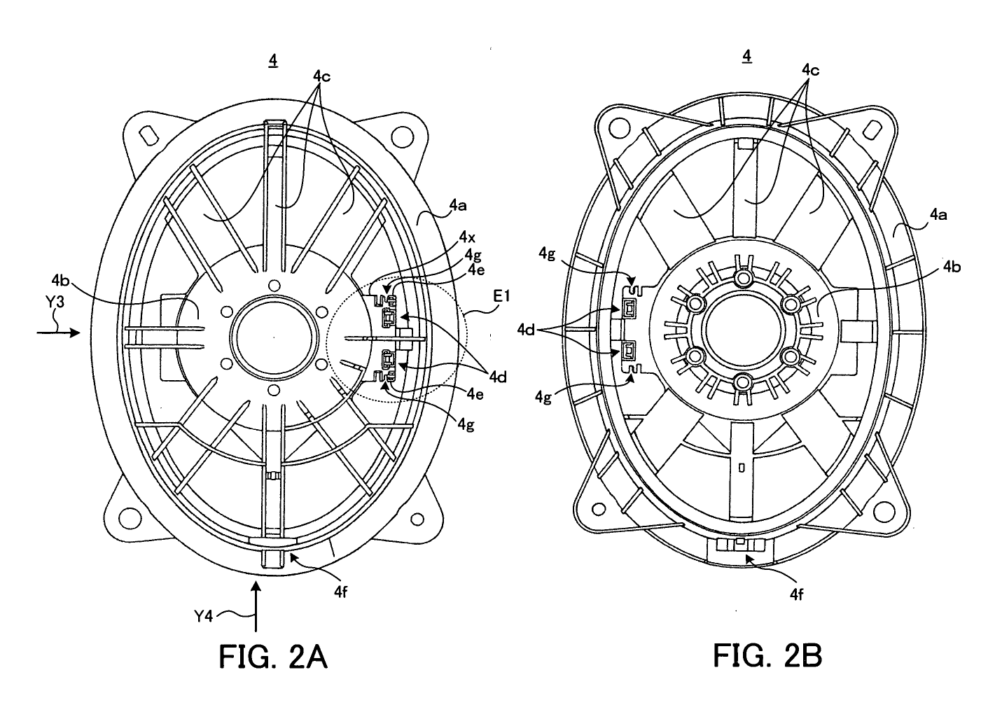

First, the configuration of the supporting body 4 will be described in details, with reference to FIGS. 2A and 2B to FIGS. 4A to 4C.

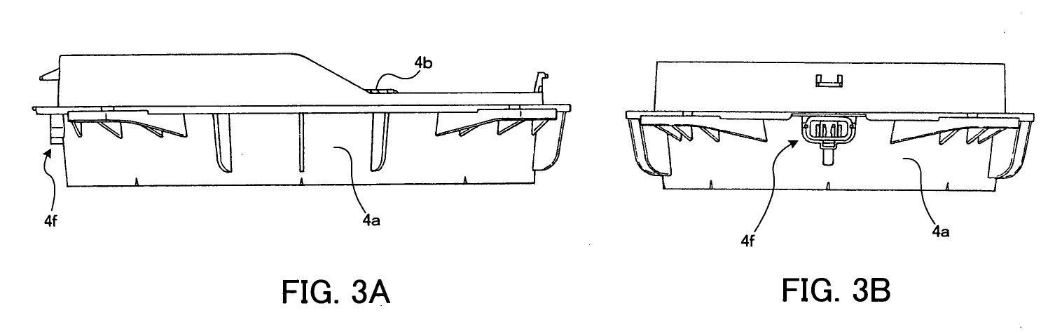

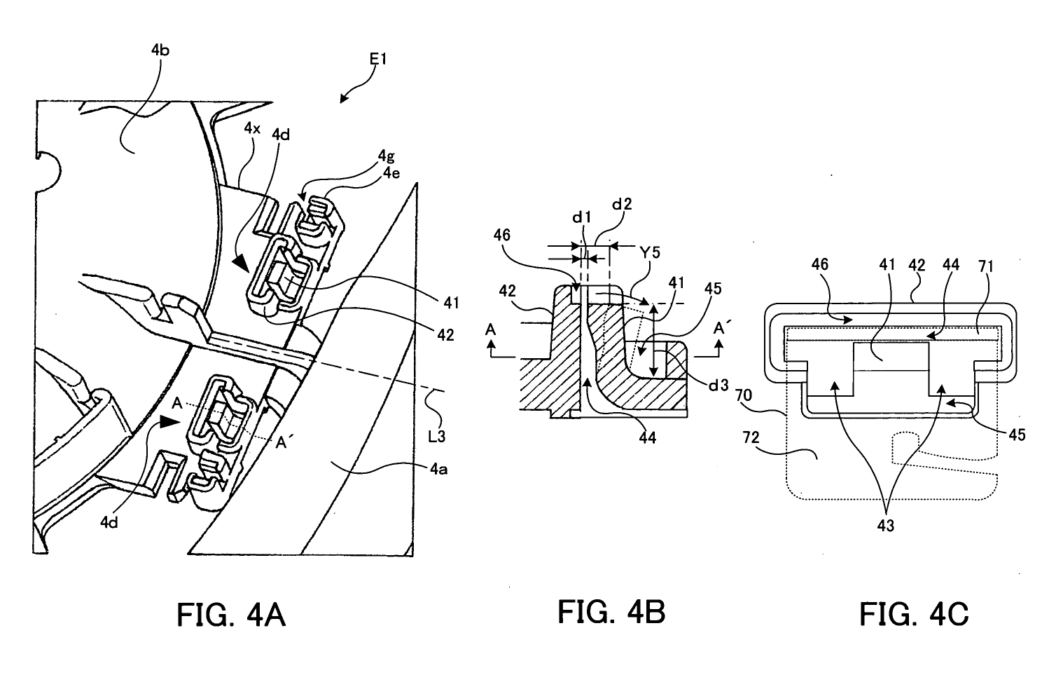

FIG. 2A shows a perspective view on the rear side of the supporting body 4 when observed from the direction of the arrow Y1 shown in FIG. 1. FIG. 2B shows a front view of the supporting body 4 when observed from the direction reverse to the direction of the arrow Y1 shown in FIG. 1. FIG. 3A shows a side view of the supporting body 4 when observed from the direction of an arrow Y3 shown in FIG. 2A. FIG. 3B shows a side view of the supporting body 4 when observed from the direction of an arrow Y4 shown in FIG. 2A. FIG. 4A is a main part enlarged perspective view of a part corresponding to a broken-line area E1 shown in FIG. 2A, in which the vicinity of a pair of terminal metal mounting parts 4d on which the terminal metals 70 are mounted is particularly enlarged and shown. FIG. 4B shows a cross-sectional view of each of the terminal metal mounting parts 4d along a cutting line A-A′ shown in FIG. 4A. FIG. 4C shows a front view of each of the terminal metal mounting parts 4d when observed from the rear side of the supporting body 4.

In a preferred example, the supporting body 4, made of a resin material, has an oval plane shape, and includes an outer peripheral part 4a provided at a position surrounding the diaphragm 8, an inner peripheral part 4b provided on the inner side of the outer peripheral part 4a and supporting the magnetic circuit 30, and plural arm parts 4c provided in the circumferential direction of the supporting body 4 with appropriate spaces therebetween and integrating the outer peripheral part 4a and the inner peripheral part 4b. In this embodiment, the supporting body 4 has the oval plane shape. However, the plane shape of the supporting body 4 is not limited to this.

The outer peripheral part 4a, having a substantially annular shape and a frame shape, has a function to support the outer peripheral part of the edge 9 integrated with the diaphragm 8. The above-mentioned connector terminal 4f is provided at the outer peripheral part 4a.

The inner peripheral part 4b, formed into a substantially annular shape, includes an overhang part 4x provided to overhang in the short diameter direction of the supporting body 4 and on the side of the outer peripheral part 4a. On the overhang part 4x positioned on the side opposite to the diaphragm 8, there are provided: the pair of terminal metal mounting parts 4d on which the pair of terminal metals 70 are mounted, respectively; slit parts 4g, each of which has a slit shape, each of which is provided at a position in the vicinity of the terminal metal mounting part 4d, and each of which the part of each tinsel cord 11 is inserted into and passes through; and tinsel cord fixing parts 4e, each of which has a recessed part, each of which is provided at a position in the vicinity of each slit part 4g and each terminal metal mounting part 4d, and each of which sandwiches and fixes the vicinity of the other end side of the tinsel cord 11 positioned on the side opposite to the voice coil 6.

The pair of terminal metal mounting parts 4d are symmetrical with respect to a straight line L3 passing through the center part of the overhang part 4x. Each of the terminal metal mounting parts 4d has a claw part 41, formed into a claw shape projecting on the side opposite to the diaphragm 8, and fixing each of the terminal metals; an adhesive accumulation part 42, having a shape surrounding the claw part 41 and a recessed shape, in which the adhesive of the constant amount is filled; a cut-out part 43 provided on both sides of the claw part 41 in the adhesive accumulation part 42; and an insertion hole 44, provided between the claw part 41 and the adhesive accumulation part 42, having a slit shape, into which the terminal metal 70 is inserted.

Each of the claw parts 41 has a length d3 enough to have a certain degree of elasticity. Concretely, the length d3 is capable of bending in the direction of an arrow Y5 thereby to enlarge the one end side (corresponding to the upper end side of FIG. 4B) of the insertion hole 44, as shown by a broken line in FIG. 4B. Namely, in FIG. 4B, the width of the one end side (upper end side) of the insertion hole 44 opposite to the vicinity of the one end side (upper end side) of each of the claw parts 41 is d1 in the initial state. However, each of the claw parts 41 has the length d3 so that, in such a case that the terminal metal 70 is inserted into the insertion hole 44 and the one end side (upper end side) of each of the claw parts 41 bends in the direction of the arrow Y5, the width of the one end side (upper end side) of the insertion hole 44 can be a length d2(>d1).

Each of the adhesive accumulation parts 42 has a first adhesive accumulation part 45, provided in the vicinity of the lower end side of the claw part 41 and having a recessed shape, and a second adhesive accumulation part 46, provided on the upper end side of the claw part 41 and having a recessed shape.

### (Configuration of Terminal Metal)

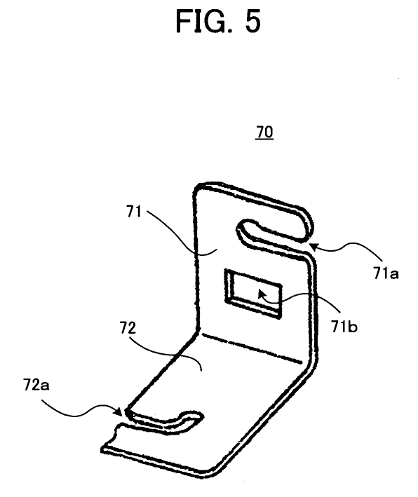

Next, a description will be given of the configuration of the terminal metals 70 mounted on the terminal metal mounting parts 4d, with reference to FIG. 5.

Each of the terminal metals 70 has a wiring connection part 71, having an L shape, which is inserted into the insertion hole 44 of the terminal metal mounting part 4d and to which each of the wirings 16 is connected, and a tinsel cord connection part 72 which is curved in a substantially right angle at the end part of the wiring connection part 71 and to which each of the tinsel cords 11 is connected.

A wiring sandwiching part 71a, having a slit shape and sandwiching each wiring 16, is provided on the one end side of each wiring connection part 71. An engagement hole 71b engaging with the one end side (upper end side) of the claw part 41 of each of the terminal metal mounting parts 4d is provided at a substantially middle part of the wiring connection part 71. Meanwhile, a tinsel cord sandwiching part 72a for sandwiching each of the tinsel cords 11, having a slit shape, is provided on the one end side of each of the tinsel cord connection parts 72.

### (Configuration of Mounting of Terminal Metal on Supporting Body)

Next, a description will be given of the configuration of mounting of the terminal metals 70 on the supporting body 4, with reference to FIGS. 6A to 6C.

FIG. 6A shows a rear view of the speaker device 100, which shows such a state that the terminal metals 70 are mounted on the terminal metal mounting parts 4d. FIG. 6B is a main part enlarged perspective view of the speaker device 100, which enlarges and shows the vicinity of the broken-line area E2 shown in FIG. 6A, which particularly shows such a state that the terminal metals 70 are mounted on the terminal metal mounting parts 4d. FIG. 6C is a main part cross-sectional view of each of the terminal metal mounting parts 4d along a cutting line B-B′ shown in FIG. 6B, and particularly shows a method of mounting of each of the terminal metals 70 on each of the terminal metal mounting parts 4d.

First, a description will be given of the method of mounting of the terminal metals 70 on the terminal metal mounting parts 4d, with reference to FIG. 6C.

In order to mount each of the terminal metals 70 on each of the terminal metal mounting parts 4d, first, the wiring connection part 71 of the terminal metal 70 is slid and inserted into the insertion hole 44 of the terminal metal mounting part 4d from the side of the diaphragm 8 to the side opposite to the diaphragm 8, as shown by an arrow Y6 in FIG. 6C. In such a state, the wiring connection part 71 of each of the terminal metals 70 is further inserted into the side opposite to the diaphragm 8. By the elasticity of the claw part 41 and the interaction between the claw part 41 and the wiring connection part 71, the claw part 41 bends in the direction (the direction of the arrow Y5 shown in FIG. 4B) of enlarging the one end side (upper end side) of the insertion hole 44, and the claw part 41 returns to the initial position and engages with the engagement hole 71b. Thereby, each of the terminal metals 70 is mounted on each of the terminal metal mounting parts 4d. The mounting state is shown in FIGS. 6A to 6C.

In such a state, the wiring connection part 71 of each of the terminal metals 70 is inserted into the insertion hole 44 of each of the terminal metal mounting parts 4d from the side opposite to the diaphragm 8, and the one end side (upper end side) of the claw part 41 of each of the terminal metal mounting parts 4d engages with an engagement hole 41b of each of the terminal metals 70. The part of each of the terminal metals 70 positioned at cut-out parts 43 provided on both sides of the claw part 41 is exposed in the adhesive accumulation part 42 of each of the terminal metal mounting parts 4d, and the part of each of the terminal metals 70, i.e., the part of the wiring connection part 71 and the part of the tinsel cord connection part 72 are fixed to each of the terminal metal mounting parts 4d via the adhesive (not shown) filled in the first adhesive accumulation part 45. In addition, the other part of each of the terminal metals 70 positioned on the one end side (upper end side) of the claw part 41 and the side connected to each of the wirings 16, i.e., the other part of the wiring connection part 71, is exposed in the second adhesive accumulation part 46, and the other part of each of the terminal metals 70 is fixed to each of the terminal metal mounting parts 4d via the adhesive (not shown) filled in the second adhesive accumulation part 46.

Additionally, the one end side of each wiring 16 is sandwiched by the wiring sandwiching part 71a provided on the one end side of the wiring connection part 71, and the connection part between the wiring sandwiching part 71a and each wiring 16 is soldered (not shown). Thereby, the wiring sandwiching part 71a and each wiring 16 are electrically connected. Meanwhile, the other end side of each tinsel cord 11 is inserted into the slit part 4g to be drawn to the side opposite to the diaphragm 8 from the side of the diaphragm 8. Then, the other end side of each tinsel cord 11 is bent on the side of the outer peripheral part 4a, and is sandwiched by the tinsel cord fixing part 4e. In such a state, the other end side of each tinsel cord 11 is further sandwiched by the tinsel cord sandwiching part 72a. The connection part between the tinsel cord sandwiching part 72a and each tinsel cord 11 is soldered (not shown). The tinsel cord sandwiching part 72a and each tinsel cord 11 are electrically connected to each other. In this manner, each tinsel cord 11 and the wiring 16 are electrically connected to each other via the terminal metal 70.

Each wiring 16 is drawn to the connector terminal 4f along the outer edge of the inner peripheral part 4b of the supporting body 4 positioned on the side opposite to the diaphragm 8, and is electrically connected to the connector terminal 4f.

Next, a description will be given of advantage of the configuration of mounting the terminal metal on the supporting body 4, according to an embodiment of the present invention, in comparison with a comparative example.

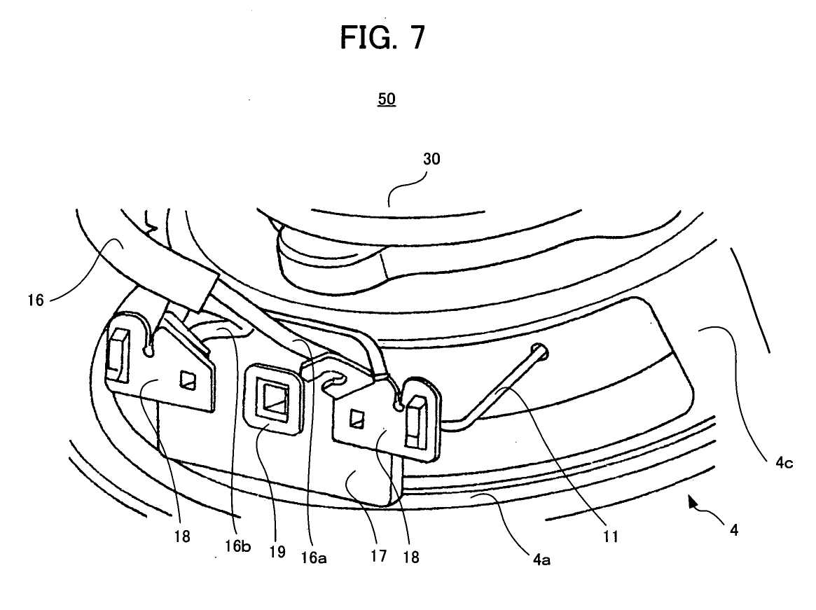

First, the configuration of mounting the terminal metal in a speaker device 50 according to the comparative example will be explained with reference to FIG. 7. FIG. 7 is a main part enlarged perspective view of the speaker device 50, showing the configuration of mounting of the terminal metal, according to the comparative example. Hereinafter, the same reference numerals are given of the same components as those of the embodiment, and explanations thereof are omitted.

The speaker device 50 according to the comparative example includes a terminal board 17 which is mounted on the supporting body 4 via a metal eyelet 19, and a pair of plus and minus terminal metals 18 which are mounted on the terminal board 17. Each one end side of the pair of plus and minus tinsel cords 11 is electrically connected to each of the terminal metals 18, and the other end side of each of the plus and minus tinsel cords 11 is electrically connected to each of the plus and minus lead wires of the voice coil 6, which is not shown. Meanwhile, the one end side of each of the plus and minus wirings 16 drawn from the connector terminal 4f (not shown) electrically connected to the output wiring of the amplifier is electrically connected to each of the terminal metals 18.

In the comparative example having the configuration, the separate terminal board 17 is provided to connect each tinsel cord 11 and each wiring 16. Therefore, the cost of the speaker device 50 problematically becomes high by the amount.

As for this point, the speaker device 100 according to the embodiment of the present invention includes the terminal metals 70 electrically connected to each tinsel cord 11 and each wiring 16, and the supporting body 4 having the terminal metal mounting parts 4d on which the terminal metals 70 are mounted. The terminal metals 70 are mounted on the terminal metal mounting parts 4d. Thereby, without providing the terminal board 17, the tinsel cords 11 and the wirings 16 can be electrically connected to each other via the terminal metals 70, respectively. Thus, as compared with the comparative example, the number of components can be reduced by the number of omitted terminal board 17, and the cost of the speaker device 100 can be reduced.

Each of the terminal metal mounting parts 4d has the insertion hole 44 for mounting each of the terminal metals 70. Therefore, by inserting each of the terminal metals 70 into the insertion hole 44 of each of the terminal metal mounting parts 4d, each of the terminal metals 70 can be mounted on each of the terminal metal mounting parts 4d. Therefore, it becomes easier to mount the terminal metals 70 on the terminal metal mounting parts 4d.

Each of the terminal metal mounting parts 4d has the claw part 41 formed into the claw shape for fixing the terminal metal 70, provided at the position opposite to the insertion hole 44, and each of the terminal metals 70 has the engagement hole 41b engaging with the claw part 41. The part of each terminal metal 70, i.e., the part of each wiring connection part 71, is inserted into the insertion hole 44, and each of the claw parts 41 engages with the engagement hole 41b. Thereby, each of the terminal metals 70 can be securely fixed to the correspondent terminal metal mounting part 4d, and it can be prevented that each of the terminal metals 70 is separated from each of the correspondent terminal metal mounting parts 4d.

Additionally, the cut-out part 43 formed by cutting out the part of each of the terminal metal mounting parts 4d is provided on both sides of each claw part 41, and the claw part 41 has the length d3 having the elasticity, i.e., the length d3 capable of bending in the direction of the arrow Y5 thereby to enlarge the one end side (corresponding to the upper end side of FIG. 4B) of the insertion hole 44, as shown by the broken line in FIG. 4B. Thereby, each of the terminal metals 70 can be easily inserted into the insertion hole 44, and the claw part 41 can easily engage with the engagement hole 41b of each of the terminal metals 70.

Each of the terminal metal mounting parts 4d has the shape surrounding the claw part 41 and the recessed shape, and has the adhesive accumulation part 42 in which the adhesive of the constant amount is filled. The part of each of the terminal metals 70 positioned in the adhesive accumulation part 42 (namely, the first adhesive accumulation part 45 and the second adhesive accumulation part 46) is exposed, and the part of each of the terminal metals 70 is fixed to each of the terminal metal mounting parts 4d via the adhesive (not shown) filled in the adhesive accumulation part 42.

Thereby, it can be prevented that the adhesive extrudes from the adhesive accumulation part 42 (i.e., from the first adhesive accumulation part 45 and the second adhesive accumulation part 46). Moreover, the terminal metals 70 can be securely fixed to the terminal metal mounting parts 4d via the adhesive. As a result, it can be prevented that the terminal metals 70 backlash against the terminal metal mounting parts 4d, and it can be further prevented that the terminal metals 70 are separated from the terminal metal mounting parts 4d.

In a preferred example, the supporting body 4 is preferably made of a resin material. Thereby, the terminal metal mounting parts 4d can be easily formed without increasing the number of procedures.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-227616 filed on Aug. 24, 2006 including the specification, claims, drawings and summary is incorporated herein by reference in its entirety.

What is claimed is:

1. A speaker device comprising:
a terminal metal which is electrically connectible to a tinsel cord and a wiring; and
a supporting body which includes a terminal metal mounting part on which the terminal metal is mounted,
wherein the terminal metal is mounted on the terminal metal mounting part.

2. The speaker device according to claim 1,
wherein the terminal metal mounting part includes an insertion hole for mounting the terminal metal.

3. The speaker device according to claim 2,
wherein the terminal metal mounting part includes a claw part formed into a claw shape for fixing the terminal metal, provided at a position opposite to the insertion hole, and the terminal metal includes an engagement hole engaging with the claw part, and
wherein a part of the terminal metal is inserted into the insertion hole, and the claw part engages with the engagement hole.

4. The speaker device according to claim 3,
wherein a cut-out part formed by cutting out a part of the terminal metal mounting part is provided on both sides of the claw part, and the claw part has a length having elasticity.

5. The speaker device according to claim 4,
wherein the claw part has a length capable of bending in a direction of enlarging one end side of the insertion hole.

6. The speaker device according to claim 3,
wherein the terminal metal mounting part, having a shape surrounding the claw part and a recessed shape, includes an adhesive accumulation part in which an adhesive of a constant amount is filled,
wherein the part of the terminal metal positioned in the adhesive accumulation part is exposed, and
wherein the part of the terminal metal is fixed to the terminal metal mounting part via the adhesive filled in the adhesive accumulation part.

7. The speaker device according to claim 1,
wherein the supporting body includes an outer peripheral part, an inner peripheral part provided on an inner side of the outer peripheral part, and an arm part for integrating the outer peripheral part and the inner peripheral part, and
wherein the terminal metal mounting part is provided at the inner peripheral part.

8. The speaker device according to claim 1,
wherein the supporting body is made of a resin material.
